(19) United States
(12) Patent Application Publication
(10) Pub. No.: US 2002/0048985 A1
(43) Pub. Date: Apr. 25, 2002

(54) Conductive member of integrated circuit socket

(76) Inventor: Kuang-Chih Lai, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/962,228

(22) Filed: Sep. 26, 2001

(30) Foreign Application Priority Data
Oct. 24, 2000 (TW) 89218482

(51) Int. Cl. H01R 4/50

(52) U.S. Cl. 439/342

(57) ABSTRACT

A conductive member of integrated circuit socket. Spring section and contact section integrally extend from two opposite sides of insertion section of the conductive member in reverse directions to form two opposite spring sections and contact sections. The pitch between two adjacent spring sections is equal to the insertion pitch between the insertion holes of the insulating seat body. Therefore, the conductive members made by punching the same blank can be fully inserted into the same row of insertion holes of the insulating seat body at one time of insertion operation.

### BACKGROUND OF THE INVENTION

1. Field of the Invention

The present invention is related to conductive members of zero insertion/extraction force integrated circuit socket, which are made by punching the same blank and can be fully inserted into the same row of insertion holes of the insulating seat body at one time of insertion operation.

2. Description of the Prior Art

In order to facilitate replacement and progress, integrated circuit including central processor unit (CPU) is generally indirectly electrically connected with a printed circuit board via an integrated circuit socket soldered on the printed circuit board. A conventional integrated circuit socket includes an insulating seat body and multiple conductive members. The insulating seat body is formed with multiple insertion holes. The distance between each two adjacent insertion holes is defined as a pitch. According to the updated specification regulated by U.S. major manufacturers, the pitch of the insertion pins of integrated circuit is 1.27 mm. Such pitch is very small so that it is impossible to make effective conductive members on a metal blank at each interval of 1.27 mm with the conventional measure. Therefore, generally the conductive member is made at two or more pitches. That is, as shown in FIGS. 10, 11 and 12, one conductive member is made by punching at 2.54 mm, 3.81 mm or 5.08 mm. In order to enhance the contacting effect, an idealistic conductive member preferably has two contact sections clamping two sides of the insertion pin of the integrated circuit. As a result, the consumed material will be more insufficient.

### SUMMARY OF THE INVENTION

It is therefore a primary object of the present invention to provide a conductive member of integrated circuit socket including: an insulating seat body formed with multiple insertion holes, a distance between any two adjacent insertion holes being defined as an insertion pitch; and multiple conductive member formed by cutting one single blank and sequentially arranged on the same blank side by side. The conductive members are respectively inserted in the insertion holes of the insulating seat body, whereby the insertion pins of the integrated circuit can be inserted into the conductive members. Each conductive member includes: a base section, two ends of the base section being integrally connected with the adjacent conductive member prior to completion of insertion operation of the conductive member, the base section having a first folding edge and a second folding edge opposite to the first folding edge, the first folding edge being connected between two ends of one side of the base section, while the second folding edge being connected between two ends of the other side of the base section; a first insertion section one end of which is integrally connected with the first folding edge and foldable relative to the base section for fixedly insertion in the insertion hole of the insulating seat body; a second insertion section which is integrally connected with the second folding edge and foldable relative to the base section for fixedly insertion in the insertion hole of the insulating seat body, after folded, the second insertion section being opposite to the folded first insertion section; and a clamping section one end of which extends from the other end of the first and second insertion sections in a direction reverse to the first and second insertion sections for an insertion pin of the integrated circuit to insert in the clamping section. The clamping section includes: at least one first spring section one end of which is integrally connected with the other end of the first insertion section; at least one first contact section one end of which is integrally connected with the other end of the first spring section; at least one second spring section one end of which is integrally connected with the other end of the second insertion section; and at least one second contact section one end of which is integrally connected with the other end of the second spring section. In an unfolded state, the first spring section is integrally connected with the other end of the first insertion section. In an unfolded state, the second spring section is integrally connected with the other end of the second insertion section. The first spring section and the first contact section and the second spring section and the second contact section respectively extend in reverse directions. The pitch between two adjacent first spring sections integrally connected with the first insertion section is defined as a first unfolding pitch. The pitch between two adjacent second spring sections integrally connected with the second insertion section is defined as a second unfolding pitch. The first spring section, first contact section and the first insertion section are further upright folded about the first folding edge of the base section. The second spring section, second contact section and the second insertion section are further upright folded about the second folding edge of the base section. The upright folded second insertion section, second spring section and the second contact section are respectively opposite to the upright folded first insertion section, first spring section and the first contact section. The first contact section, first spring section, first insertion section, base section, second insertion section, second spring section and the second contact section together form a U-shaped structure. The aforesaid first unfolded pitch is equal to the second unfolded pitch and the first unfolded pitch and second unfolded pitch are both equal to the insertion pitch, whereby the conductive members made by punching the same blank can be fully inserted into the same row of insertion holes of the insulating seat body at one time of insertion operation.

It is a further object of the present invention to provide the above conductive member of integrated circuit socket in which each of the first and second contact sections of any conductive member has a first slope which first contacts with the insertion pin of the integrated circuit. The first slope serves to guide the insertion pin to easily slide into the space between the opposite first and second contact sections.

It is still a further object of the present invention to provide the above conductive member of integrated circuit socket in which each of the first and second contact sections of any conductive member has a second slope which last contacts with the insertion pin of the integrated circuit. The second slope serves to prevent the insertion pin from slipping out of the space between the first and second contact sections, whereby the insertion pin of the integrated circuit is more firmly clamped and fixed.

It is still a further object of the present invention to provide the above conductive member of integrated circuit socket in which the base section is further formed with a soldering hole passing through the base section, whereby through the soldering hole, it can be checked whether the solder is truly filled in the space between the base section and the printed circuit board.

The present invention can be best understood through the following description and accompanying drawings wherein:

### BRIEF DESCRIPTION OF THE DRAWINGS

FIG. 1 is a top view of the conductive members of the present invention, which are inserted in the insulating seat body;

FIG. 2 is a sectional view taken along line 2-2 of FIG. 1;

FIG. 3 is a sectional view according to FIG. 2, in which the insertion pins of the integrated circuit are moved to a contact position;

FIG. 4 is a plane view showing that the conductive members are made by punching a blank and are still connected together in an unfolded state;

FIG. 5 shows one single conductive member taken from FIG. 4 in an unfolded state;

FIG. 6 is a side view of the single conductive member of FIG. 5, which is folded;

FIG. 7 is an enlarged view of a part of the integrated circuit socket;

FIG. 8 is a front view of the conductive member of the present invention according to FIG. 7;

FIG. 9 is a top view of the conductive member of the present invention according to FIG. 8;

FIG. 10 is a plane unfolded view showing that each conventional conductive member is cut at two pitches;

FIG. 11 is a side view of the conventional conductive member of FIG. 10 in a folded state; and

FIG. 12 is a top view of the conventional conductive member of FIG. 11 in a folded state.

### DETAILED DESCRIPTION OF THE PREFERRED EMBODIMENT

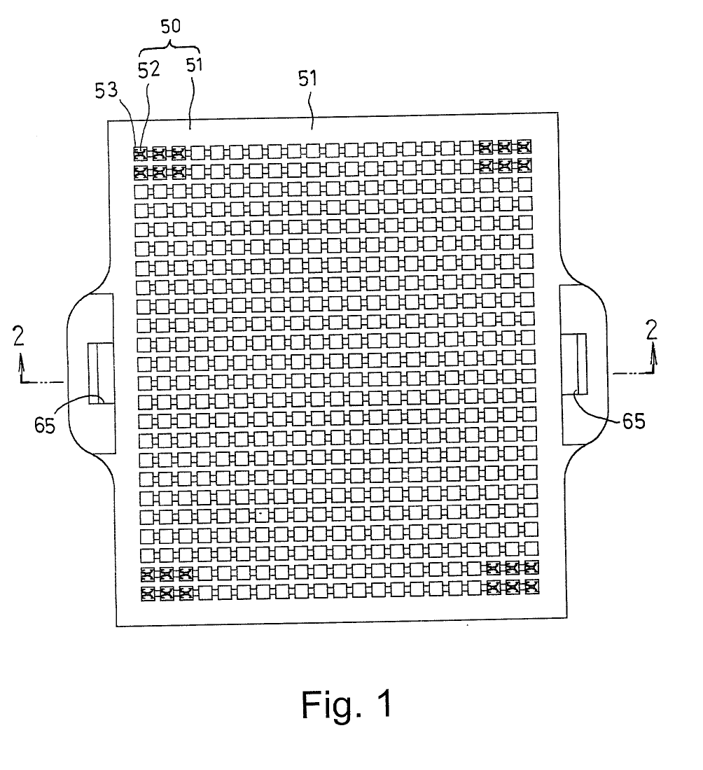

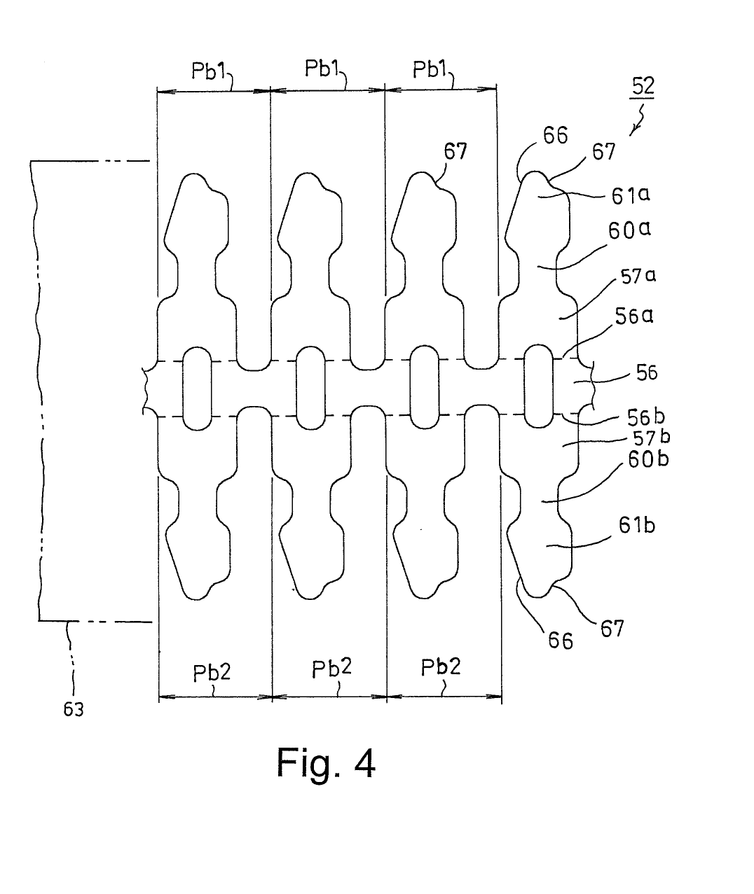

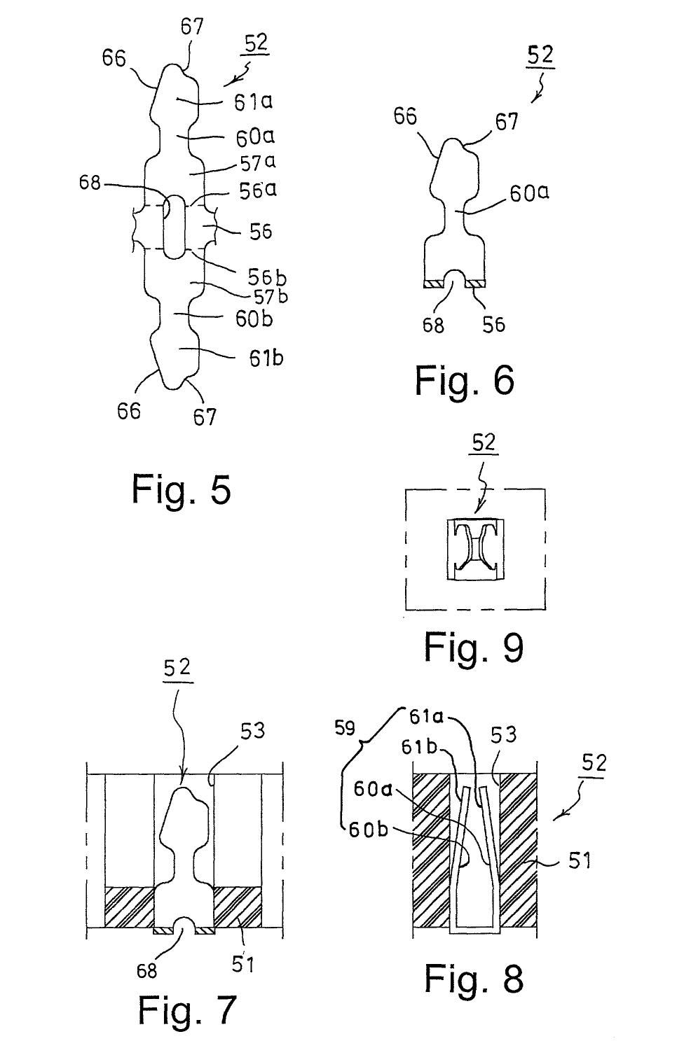

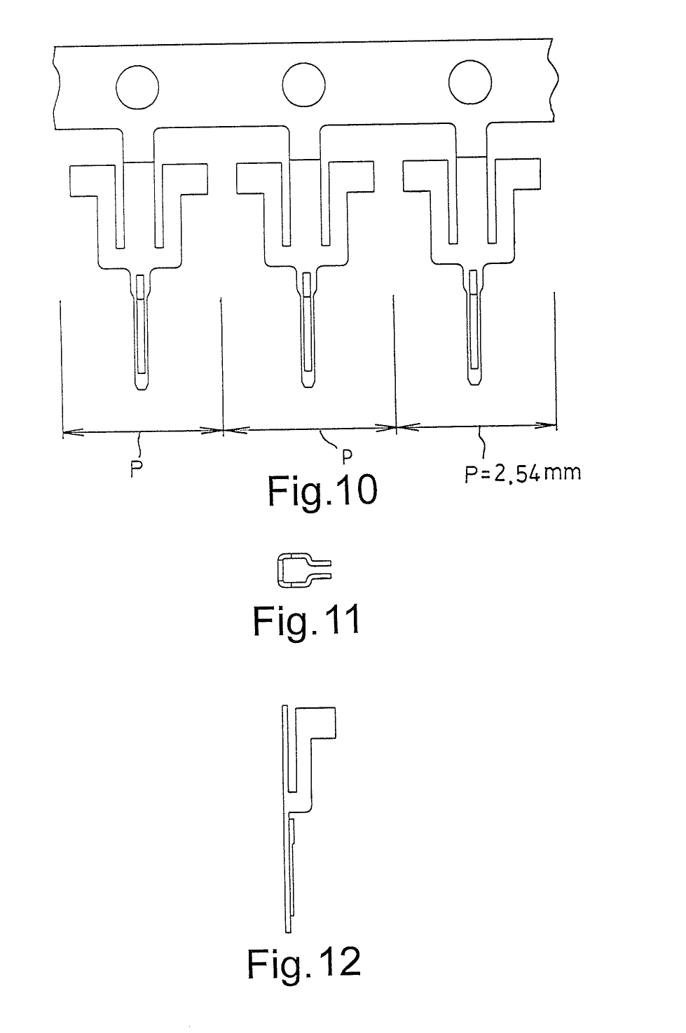

Please refer to FIGS. 1 to 9 which show the conductive member of integrated circuit socket of the present invention. The integrated circuit socket 50 includes an insulating seat body 51 and multiple conductive members 52. The insulating seat body 51 is formed with multiple insertion holes 53. The distance between any two adjacent insertion holes 53 is defined as an insertion pitch Pa.

The conductive members 52 are formed by cutting one single blank 63 and are sequentially arranged on the same blank 63 side by side. The conductive members 52 are respectively inserted in the insertion holes 53 of the insulating seat body 51, whereby the insertion pins 55 of the integrated circuit can be inserted into the conductive members 52.

Each conductive member includes a base section 56, a first insertion section 57a, a second insertion section 57b and a clamping section 59. Two ends of the base section 56 are integrally connected with the adjacent conductive member prior to completion of insertion operation of the conductive member. The base section 56 has a first folding edge 56a and a second folding edge 56b opposite to the first folding edge 56a. The first folding edge 56a is connected between two ends of one side of the base section 56, while the second folding edge 56b is connected between two ends of the other side of the base section 56.

One end of the first insertion section 57a is integrally connected with the first folding edge 56a and foldable relative to the base section 56 for fixedly insertion in the insertion hole 53 of the insulating seat body 51.

The second insertion section 57b is integrally connected with the second folding edge 56b and foldable relative to the base section 56 for fixedly insertion in the insertion hole 53 of the insulating seat body 51. After folded, the second insertion section 57b is opposite to the folded first insertion section 57a.

One end of the clamping section 59 extends from the other end of the first and second insertion sections 57a, 57b in a direction reverse to the first and second insertion sections 57a, 57b. An insertion pin 55 of the integrated circuit is inserted in the clamping section 59.

The clamping section 59 includes at least one first spring section 60a, at least one first contact section 6 la, at least one second spring section 60b and at least one second contact section 6 lb. One end of the first spring section 60a is integrally connected with the other end of the first insertion section 57a. One end of the first contact section 61a is integrally connected with the other end of the first spring section 60a. One end of the second spring section 60b is integrally connected with the other end of the second insertion section 57b. One end of the second contact section 61b is integrally connected with the other end of the second spring section 60b.

In an unfolded state, the first spring section 60a is integrally connected with the other end of the first insertion section 57a. In an unfolded state, the second spring section 60b is integrally connected with the other end of the second insertion section 57b. The first spring section 60a and the first contact section 61a and the second spring section 60b and the second contact section 61b respectively extend in reverse directions. The pitch between two adjacent first spring sections 60a integrally connected with the first insertion section 57a is defined as a first unfolding pitch Pb1. The pitch between two adjacent second spring sections 60b integrally connected with the second insertion section 57b is defined as a second unfolding pitch Pb2. The first spring section 60a, first contact section 61a and the first insertion section 57a are further upright folded about the first folding edge 56a of the base section 56. The second spring section 60b, second contact section 61b and the second insertion section 57b are further upright folded about the second folding edge 56b of the base section 56. The upright folded second insertion section 57b, second spring section 60b and the second contact section 61b are respectively opposite to the upright folded first insertion section 57a, first spring section 60a and the first contact section 61a, whereby the first contact section 61a, first spring section 60a, first insertion section 57a, base section 56, second insertion section 57b, second spring section 60b and the second contact section 61b together form a U-shaped structure.

The aforesaid first unfolded pitch Pb1 is equal to the second unfolded pitch Pb2, that is, Pb1=Pb2. Also, the first unfolded pitch Pb1 and second unfolded pitch Pb2 are both equal to the insertion pitch Pa, that is, Pa=Pb1=Pb2=1.27 mm. Therefore, the conductive members made by punching the same blank can be fully inserted into the same row of insertion holes of the insulating seat body at one time of insertion operation.

Each of the first and second contact sections 61a, 61b of any conductive member 52 has a first slope 66 which first contacts with the insertion pin 55 of the integrated circuit. The first slope 66 serves to guide the insertion pin 55 to easily slide into the space between the opposite first and second contact sections 61 a and 61b. Each of the first and second contact sections 61a, 61b of any conductive member has a second slope 67 which last contacts with the insertion pin 55 of the integrated circuit. The second slope 67 serves to prevent the insertion pin 55 from slipping out of the space between the opposite first and second contact sections 61a and 61b. Accordingly, the insertion pin 55 of the integrated circuit is more firmly clamped and fixed.

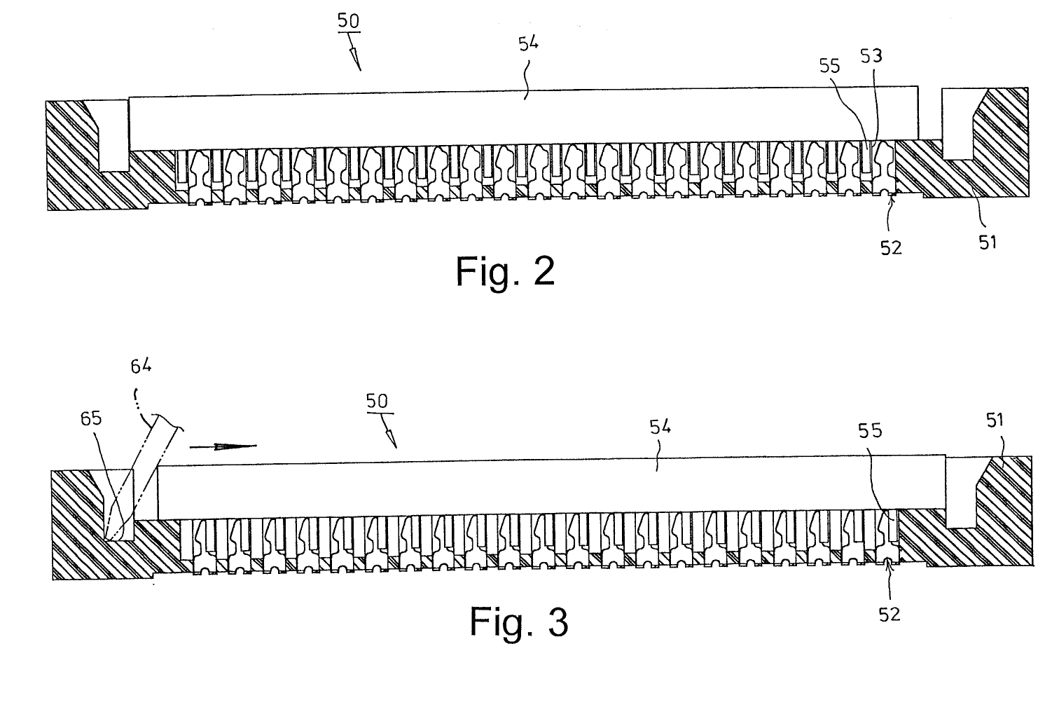

As shown in FIGS. 2 and 3, the insertion pin 55 of the integrated circuit 54 is inserted into the insertion hole 53 of the insulating seat body 51, but not yet contacts with the first and second contact sections 61a and 61b of the conductive member 52. Then, a screwdriver 64 is inserted into a fulcrum dent 65 and biased leftward to move the integrated circuit leftward. Accordingly, the insertion pin 55 of the integrated circuit is guided by the first slopes 66 of the first and second contact sections 61a and 61b to smoothly slide into the space between the first and second contact sections 61a and 61b as shown in FIGS. 2, 3 and 7. The second slopes 67 at the other ends of the first and second contact sections 61a and 61b forcedly push the insertion pin 55 so as to effectively prevent the insertion pin 55 from slipping out of the space between the first and second contact sections 61a and 61b. Accordingly, the insertion pin 55 of the integrated circuit is more firmly clamped and fixed.

The base section 56 is further formed with a soldering hole 68 passing through the base section 56. Through the soldering hole 68, it can be checked whether the solder is truly filled in the space between the base section 56 and the printed circuit board (not shown).

According to the above arrangement, the present invention has the following advantages:

1. According to the conductive member of zero insertion/extraction force integrated circuit socket of the present invention, the spring section and contact section integrally extend from two opposite sides of the insertion section of the conductive member. The unfolded pitch between two adjacent spring sections integrally connected with the same side of the insertion section is equal to the insertion pitch. Therefore, in each pitch of 1.27 mm, a complete conductive member with maximum width can be made by cutting the blank. That is, the unfolded pitch of the entire row of conductive members is 1.27 mm. Accordingly, the conductive members made by punching the same blank can be fully inserted into the same row of insertion holes of the insulating seat body at one time of insertion operation.

2. Each of the contact sections of any conductive member has a first slope which first contacts with the insertion pin of the integrated circuit. The first slope serves to guide the insertion pin to be easily pushed and clamped in the space between the opposite contact sections.

3. Each of the contact sections of any conductive member has a second slope which last contacts with the insertion pin of the integrated circuit. The second slope serves to prevent the insertion pin from slipping out of the space between the contact sections. Accordingly, the insertion pin of the integrated circuit is more firmly clamped and fixed.

4. The base section is further formed with a soldering hole passing through the base section. Through the soldering hole, it can be checked whether the solder is truly filled in the space between the base section and the printed circuit board.

The above embodiment is only used to illustrate the present invention, not intended to limit the scope thereof. Many modifications of the above embodiment can be made without departing from the spirit of the present invention.

What is claimed is:

1. A conductive member of integrated circuit socket comprising:
an insulating seat body formed with multiple insertion holes, a distance between any two adjacent insertion holes being defined as an insertion pitch; and
multiple conductive member formed by cutting one single blank and sequentially arranged on the same blank side by side, the conductive members being respectively inserted in the insertion holes of the insulating seat body, whereby the insertion pins of the integrated circuit can be inserted into the conductive members, each conductive member including: a base section, two ends of the base section being integrally connected with the adjacent conductive member prior to completion of insertion operation of the conductive member, the base section having a first folding edge and a second folding edge opposite to the first folding edge, the first folding edge being connected between two ends of one side of the base section, while the second folding edge being connected between two ends of the other side of the base section; a first insertion section one end of which is integrally connected with the first folding edge and foldable relative to the base section for fixedly insertion in the insertion hole of the insulating seat body; a second insertion section which is integrally connected with the second folding edge and foldable relative to the base section for fixedly insertion in the insertion hole of the insulating seat body, after folded, the second insertion section being opposite to the folded first insertion section; and a clamping section one end of which extends from the other end of the first and second insertion sections in a direction reverse to the first and second insertion sections for an insertion pin of the integrated circuit to insert in the clamping section, the clamping section including: at least one first spring section one end of which is integrally connected with the other end of the first insertion section; at least one first contact section one end of which is integrally connected with the other end of the first spring section; at least one second spring section one end of which is integrally connected with the other end of the second insertion section; and at least one second contact section one end of which is integrally connected with the other end of the second spring section, in an unfolded state, the first spring section being integrally connected with the other end of the first insertion section, in an unfolded state, the second spring section being integrally connected with the other end of the second insertion section, the first spring section and the first contact section and the second spring section and the second contact section respectively extending in reverse directions, the pitch between two adjacent first spring sections integrally connected with the first insertion section being defined as a first unfolding pitch, the pitch between two adjacent second spring sections integrally connected with the second insertion section being defined as a second unfolding pitch, the first spring section, first contact section and the first insertion section being further upright folded about the first folding edge of the base section, the second spring section, second contact section and the second insertion section being further upright folded about the second folding edge of the base section, the upright folded second insertion section, second spring section and the second contact section being respectively opposite to the upright folded first insertion section, first spring section and the first contact section, whereby the first contact section, first spring section, first insertion section, base section, second insertion section, second spring section and the second contact section together form a U-shaped structure, the aforesaid first unfolded pitch being equal to the second unfolded pitch and the first unfolded pitch and second unfolded pitch being both equal to the insertion pitch, whereby the conductive members made by punching the same blank can be fully inserted into the same row of insertion holes of the insulating seat body at one time of insertion operation.

2. The conductive member of integrated circuit socket as claimed in claim 1, wherein each of the first and second contact sections of any conductive member has a first slope which first contacts with the insertion pin of the integrated circuit, the first slope serving to guide the insertion pin to easily slide into the space between the opposite first and second contact sections.

3. The conductive member of integrated circuit socket as claimed in claim 1 or 2, wherein each of the first and second contact sections of any conductive member has a second slope which last contacts with the insertion pin of the integrated circuit, the second slope serving to prevent the insertion pin from slipping out of the space between the first and second contact sections, whereby the insertion pin of the integrated circuit is more firmly clamped and fixed.

4. The conductive member of integrated circuit socket as claimed in claim 1 or 2, wherein the base section is further formed with a soldering hole passing through the base section, whereby through the soldering hole, it can be checked whether the solder is truly filled in the space between the base section and the printed circuit board.
